(19) United States
(12) Patent Application Publication
(10) Pub. No.: US 2003/0002967 A1
(43) Pub. Date: Jan. 2, 2003

(54) Lift and align table

(76) Inventor: Amy R. Griffin, Meridian, ID (US)

Correspondence Address: DICKSTEIN SHAPIRO MORIN & OSHINSKY LLP, 2101 L STREET NW, WASHINGTON, DC, 20037-1526, US

(21) Appl. No.: 09/893,619

(22) Filed: Jun. 29, 2001

(51) Int. Cl. B60P 1/02

(52) U.S. Cl. 414/495

(57) ABSTRACT

The present provides a lift and align table, having an adjustable support for positioning a piece of equipment, comprising a base frame, a middle plate, and an upper plate, a lifting mechanism disposed between the base frame and the middle plate, and a sliding mechanism disposed between the middle plate and an upper plate.

### FIELD OF THE INVENTION

The present invention relates to an apparatus and a method for transferring heavy or awkward objects to a desired destination, and more particularly, to a lift and align table capable of moving an object in multiple directions.

### BACKGROUND OF THE INVENTION

In many areas of commercial industry, it is necessary to move objects that are too heavy, or awkwardly shaped to a final destination. One such application, where moving and positioning a heavy object is necessary, is the semiconductor industry where test heads, for testing semiconductor chips, require precise alignment with a handler.

Stationary jacking mechanisms exist that can lift heavy objects vertically, while stationary conveyers exist that can move a heavy object in a horizontal direction. However, there exists a need for a device, and a method, that can enable the transfer a heavy object, such as a semiconductor chip test head, on one compact mobile device that integrates mechanisms that can lift and align the object adjacent to a desired location.

### SUMMARY OF THE INVENTION

The present invention solves this need by providing, in one embodiment, a lift and align table having an adjustable support for positioning a piece of equipment comprising a base frame, a middle plate, and an upper plate, a lifting mechanism disposed between the base frame and the middle plate, and a sliding mechanism disposed between the middle plate and an upper plate.

The lift and align table of the present invention can be used for positioning an object, such as a semiconductor chip test head, to a desired destination, such as a handler, by placing the object on a support section of the table, moving the table toward a desired destination for said object, operating a lift mechanism to move the support section vertically and operating a slide mechanism to move the support section horizontally, thereby delivering the object to its desired location.

Additional features and advantages of the present invention will be more clearly apparent from the detailed description which is provided in connection with accompanying drawings which illustrate exemplary embodiments of the invention.

### BRIEF DESCRIPTION OF THE DRAWINGS

FIG. 1 is a perspective view of a lift and align table in accordance with an embodiment of the present invention;

FIG. 2 is a top view of a base frame in accordance with an embodiment of the present invention;

FIG. 3 is a perspective view of a base frame in accordance with an embodiment of the present invention;

FIG. 4 is a schematic view of a lift mechanism in accordance with an embodiment of the present invention;

FIG. 5 is a side view of a jacking mechanism in accordance with an embodiment of the present invention;

FIG. 6 is a side view a gas cylinder assembly in accordance with an embodiment of the present invention;

FIG. 7 is a perspective view of a slide mechanism in accordance with an embodiment of the present invention;

FIG. 8 is a perspective view of an upper plate in accordance with an embodiment of the present invention;

FIG. 9 is an illustration a lift and align table in accordance with an embodiment of the present invention in use; and,

FIG. 10 is another illustration a lift and align table in accordance with an embodiment of the present invention in use.

### DETAILED DESCRIPTION OF THE INVENTION

In the following detailed description, reference is made to various specific embodiments in which the invention may be practiced. These embodiments are described with sufficient detail to enable those skilled in the art to practice the invention, and it is to be understood that other embodiments may be employed, and that structural and procedural changes may be made without departing from the spirit or scope of the present invention.

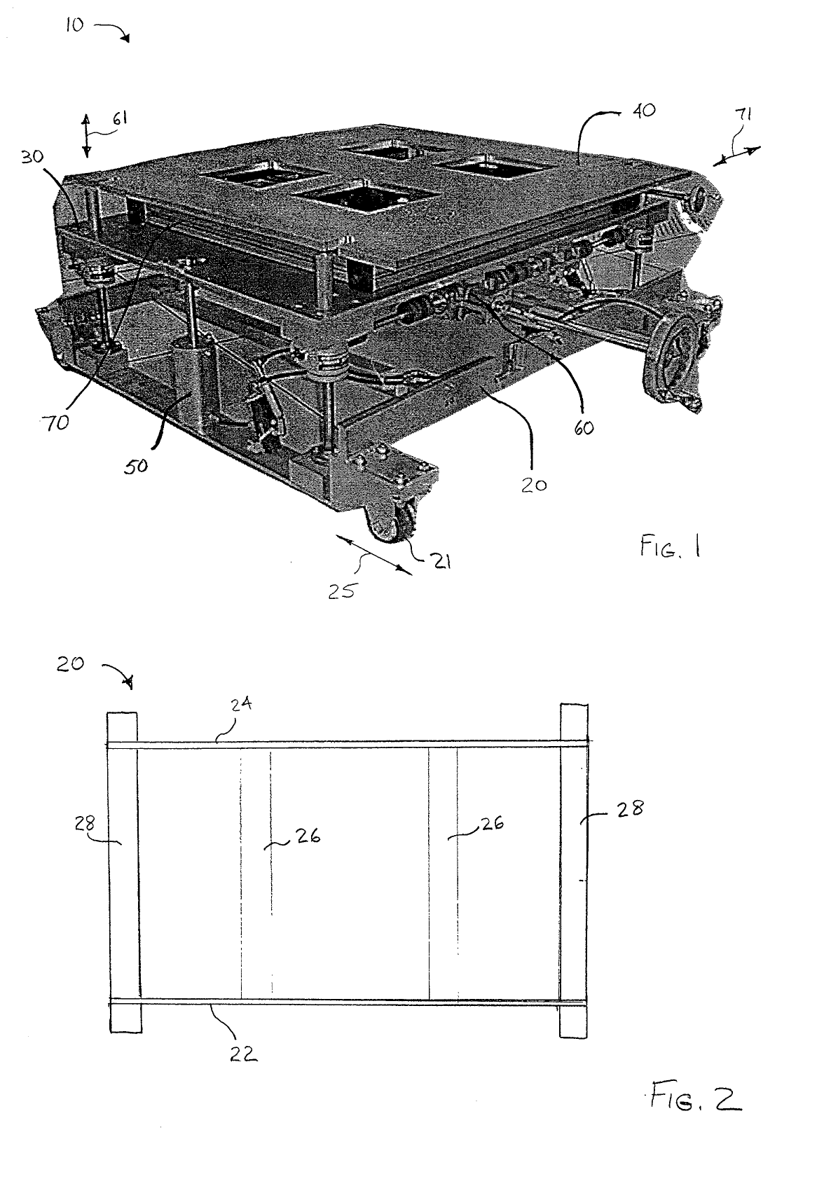

Referring now to the drawings, where like elements are designated by like reference numerals, FIG. 1 depicts an assembled lift table generally designated by the numeral 10. The lift table 10 has a base frame 20, a middle plate 30, and an upper plate 40. A lift mechanism 60 is provided between the base frame 20 and the middle plate 30. In use, and as will be discussed in greater detail herein, the lift mechanism 60 operates to move middle plate in a vertical direction, indicated by arrows 61, with respect to the base frame 20. The lift table 10 also has gas cylinder assemblies 50 disposed between the base frame 20 and the middle plate 30. As will be described herein, the gas cylinder assemblies 50 may be used to assist the lift mechanism 60 to move the middle plate 30 in the direction of arrows 61. Alternatively, the gas cylinder assemblies 50 alone can be utilized to move the middle plate 30 in a vertical direction.

The base frame 20 has wheels 21 that allow the lift table 10 to roll along a surface supporting the lift table 10. In an exemplary embodiment, the lift table 10 has four wheels 21, one disposed in each corner, as illustrated in FIG. 1. In the embodiment shown the wheels 21 are non-swivel type, allowing for precise movement in a direction indicated by arrows 25. However, the wheels 21 can be of the swivel-type, allowing for movement of the lift table 10 in various directions. Also, the number of wheels 21 can be increased to provide additional stability or ease of movement of the lift table 10, if so desired.

The lift table 10 is further provided with an upper plate 40, as illustrated in FIG. 1. A slide mechanism 70 is disposed between the upper plate 40 and the middle plate 30. In use, as will be described in greater detail below, the slide mechanism 70 operates to move the upper plate 40 relative to the middle plate 30 in a direction indicated by arrows 71.

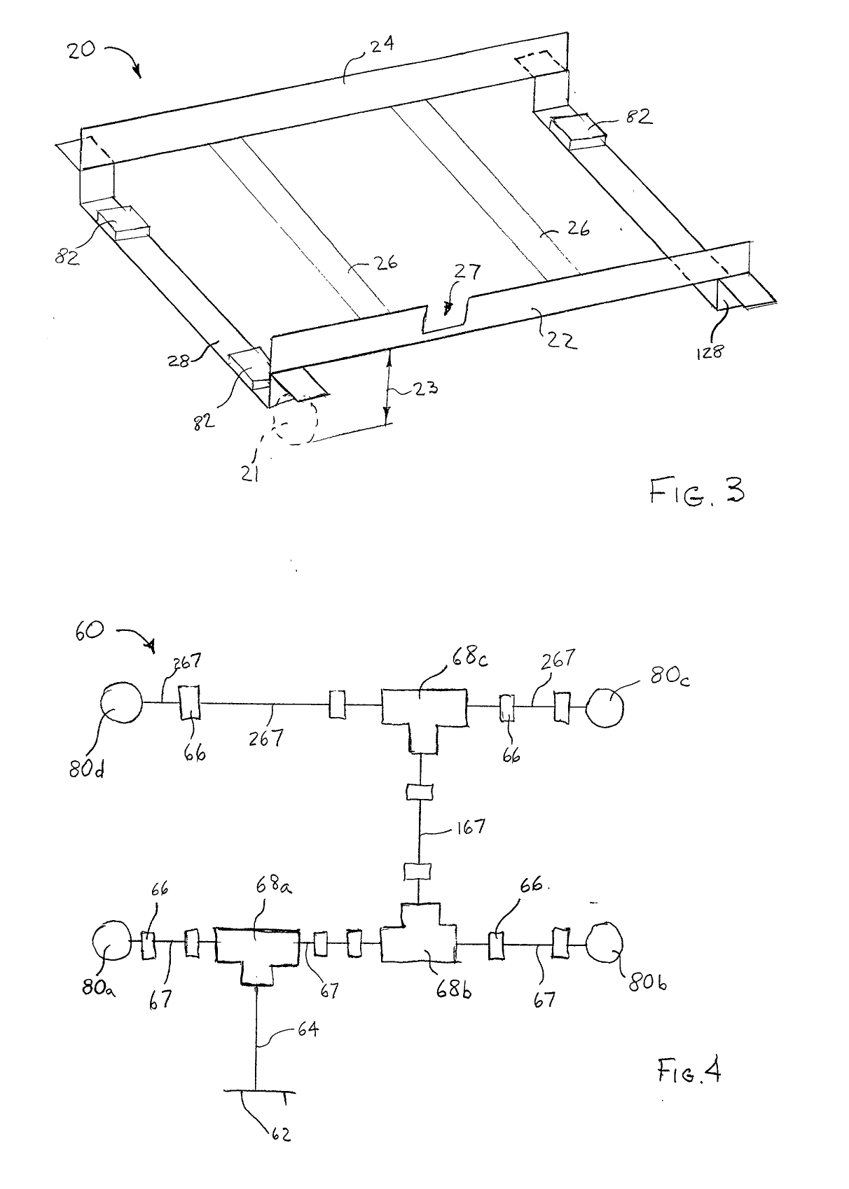

An exemplary embodiment of the base frame 20 is illustrated in greater detail in FIGS. 2 and 3, that show top and perspective views, respectively. The base frame 20 has two side braces 28 located at opposite sides of base frame 20. The side braces 28 can be made from a material such as flat-bar steel, and are straight throughout most of their length. Each side brace 28 has, at both ends, cupped recesses 128 to accommodate the wheels 21. The recesses 128 may alternatively, or additionally, be provided closer to the mid-span of the side brace 28.

The base frame 20 further has two x-braces; a rear x-brace 24 and a front x-brace 22. The front x-brace 22 has a recess 27 that can accommodate a shaft associated with the lift mechanism 60, as will be discussed below. The x-braces 22, 24 are attached to the side braces 28 at the top of the cupped recesses 128, as shown in FIG. 3. The base frame 20 also has two y-braces 26 installed between the x-braces 22, 24 as shown in FIGS. 2 and 3.

Because the x-braces 22, 24 are mounted on top of the cupped recesses 128, a clearance space indicated by arrows 23 is created between the x-braces 22, 23 and the surfaces on which the lift table 10 is positioned. This clearance space 23 is a useful feature of the present invention because it enables the lift table 10 to move along, or over, obstructions such as bundles of cables (not shown) that can be present on a working surface.

Base frame 20 structural components 22, 24, 26, 28 may be connected to one another using arc or gas welding, mechanical connections using bolts, or any other suitable fastening technique. The structural components of the base frame 20, as illustrated, are made from flat metal bar. Alternatively, the base frame 20 components may be made from C-channel or I-beam, or another type of metal stock, that would allow flexibility of handling various types of loads. The comparative strength characteristics of such structures and materials are known in the art and are not discussed herein.

Next, the lift mechanism 60 will be described. The lift mechanism 60, which is disposed between the base frame 20 and the middle plate 30, is shown from a top view in a schematic representation in FIG. 4. The lift mechanism 60 has a handwheel 62 connected to an input shaft 64. The lift mechanism 60 has three gearboxes 68a, 68b, 68c, multiple couplings 66 and transmission shafts 67, 167, 267, and four jacking mechanisms 80a, 80b, 80c, 80d arranged as shown.

In use, the handwheel 62, and thereby input shaft 64, are rotated by an external rotational force. Gearbox 68a transmits the rotational force from the input shaft 64 in two directions, perpendicular to input shaft 64, to transmission shaft 67. In one direction, the transmission shaft 67 transmits the rotational force to the jacking mechanism 80a, and in the other, to jacking mechanism 80b. Prior to reaching the jacking mechanism 80b, the transmission shaft 67 passes through gearbox 68b which also directs the rotational force from shaft 67 onto transmission shaft 167, which is perpendicular to transmission shaft 67. Transmission shaft 167 connects to gearbox 68c, which in turn transmits the rotational force from transmission shaft 167, in two directions, onto transmission shaft 267. Transmission shaft 267 is perpendicular to shaft 167 and parallel to shaft 67. Transmission shaft 267 transmits the rotational force to jacking mechanisms 80c and 80d.

Couplings 66 are provided at various locations on shafts 67, 167, and 267, as shown. The couplings 66 make semi-permanent connections between sections of shafts and facilitate assembly and disassembly of the multiple shaft sections, gearboxes, and jacking mechanisms of the lift mechanism 60. The couplings 66 may by rigid type (for perfectly aligned shafts), flexible type (for misaligned shafts), fluid type (with no mechanical connection between the shafts), or any other type of coupling suitable for transmitting a rotational force.

The jacking mechanisms 80a, b, c, d, will be described collectively with reference to FIG. 5 which shows the construction of each. The jacking mechanisms 80 are disposed between the side braces 28 of the base frame 20 and the middle plate 30 (FIGS. 1 and 5). The jacking mechanism 80 comprises a lower mount block 82 that is mounted atop the side brace 28, an upper mount block 84 that is mounted underneath the middle plate 30, and a transmission module 88 which is located beneath the lower mounting block 84. The mount blocks 82, 84 may be attached to side braces 28 and middle plate 30 using various welding techniques, mechanical fasteners, or other suitable fastening methods. A threaded jacking screw 86 extends from the lower mount block 82, through the transmission module 88 and upper mount block 84, and into a jacking screw housing 89. The transmission shafts 67, 267 connect to transmission modules 88 as shown in FIG. 5. The threaded jacking screws 86 are perpendicular to transmission shafts 67, 167, 267.

In use, as rotational force is inputted to the input shaft 62, the rotational force is transmitted through transmission shafts 67, 267 to the jacking mechanisms 80a, b, c, d. The rotational force causes shafts 67, 267 to rotate in the direction of arrows 85, as shown in FIG. 5. The rotational force of shafts 67, 267 is transmitted, through a linkage, such as a worm gear (not shown), to a jacking nut 81 disposed within the transmission module 88, causing the jacking nut 81 to rotate in a direction indicated by directional arrows 181. The jacking nut 81 has internal threads that are engaged with threads on the threaded jacking screw 86. Rotation of jacking nut 81 causes the transmission module 88 to travel vertically along the jacking screw 86 in a direction indicated by direction arrows 87. The upper mount block 84, middle plate 30, and jacking screw housing 89 are not engaged with jacking screw 86 and move freely along the jacking screw 86. Therefore, as the transmission module 88 moves vertically along the jacking screws 86 of each one of four jacking mechanisms 80a, b, c, d, cause the middle plate 30 to move vertically relative to the base frame 20.

The lift mechanism 60 alone is sufficient to move vertically the middle plate 30 relative to the base frame 20. The illustrated and described configuration for lift mechanism 60 is only illustrative. Clearly, as will be evident to a person skilled in the art, many variations can be implemented to the lift mechanism 60, i.e. adding input or transmission shaft sections, increasing the number of jacking mechanisms, etc., to accommodate changing structural, spatial, and end use requirements.

Referring now to FIG. 6, gas cylinder assemblies 50 will be described. Each gas cylinder assembly 50 comprises a gas cylinder 52, a piston 54, a piston block 56, and a gas supply line 59 that connects to the cylinder 52 through a fitting 58. The gas cylinder 52 is mounted on the side brace 28, and the piston block 56 is mounted on the middle plate 30, using welding or mechanical fasteners or other suitable techniques. In use, pressurized gas is administered from an external source (not shown) through a supply line 159 to a 3-way valve 57. The supply line 159 may also incorporate a check valve 158 that prevents the pressurized gas from flowing back to the source. The 3-way valve 57 functions to permit flow of pressurized gas into the gas cylinder 52 when it is being pressurized, and to vent pressurized gas from the gas cylinder 52, through a vent port (not shown), when the gas cylinder 52 is being depressurized.

Pressurized gas is admitted, via gas supply line 59, to the gas cylinder 52. The pressurized gas acts against the bottom surface 55 of the piston 52 to cause the piston to move vertically, in the direction indicated by arrows 53, in response to increasing and decreasing gas pressure. Because the piston 54 is fixed to the middle plate 30 by the piston block 56, the middle plate 30 is also urged to move in the direction of arrows 53 corresponding to the movement of the piston 54.

In an exemplary embodiment of the present invention, two gas cylinder assemblies are provided at midspans of the side braces 28, as illustrated in FIG. 1. In this embodiment, the function of the gas cylinders 50 is to assist with the vertical movement of middle plate 30 relative to the base frame 20. The force exerted by the pistons 54 on the middle plate 30 will be complementary to the force applied to the middle plate 30 by the jacking mechanisms 80, as described above. As noted above, the lifting force provided by lift mechanism 60 alone can be sufficient. The force supplied by the gas cylinder assemblies is complementary because, when the jacking mechanisms 80 and the associated components of lift mechanism 60 are engaged, the jacking screws 86 and associated shafts 67, 167, 267 must turn in order for the middle plate to move vertically.

The above described lifting method is merely illustrative and is not meant to suggest that this invention is so limited. The vertical movement of plate 30 can be accomplished, for example, solely with four gas cylinders disposed in place of the jacking mechanisms 80. Alternatively, hydraulic cylinder assemblies may be used instead of gas cylinder assemblies 50. Also, although an exemplary embodiment is described having a pressurized gas (or hydraulic fluid) source external to the lift table 10, a pressurized gas source may be installed within the lift table 10.

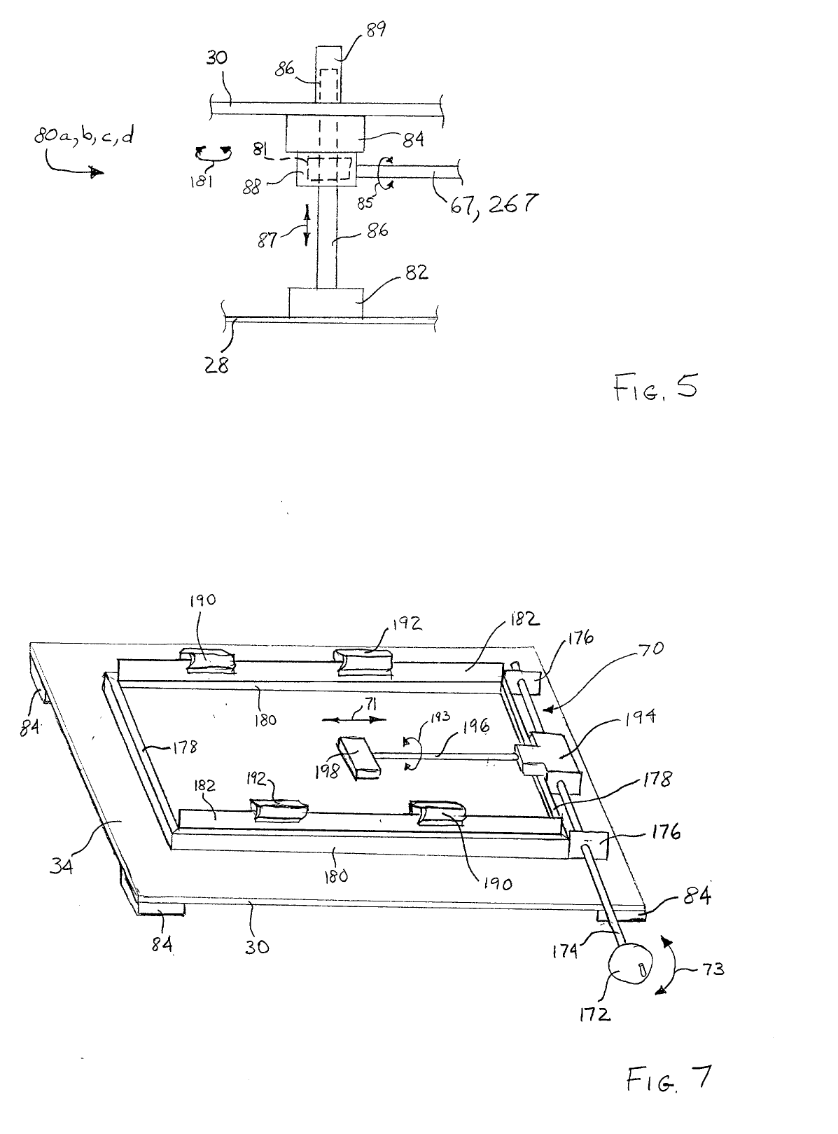

Referring now to FIG. 7, the slide mechanism 70 will be described. The slide mechanism is disposed on the top surface 34 of the middle plate 30. The slide mechanism includes a support frame that has two side supports 178 and two rail supports 180 arranged as shown. Two slider block rails 182 are attached to top of the two rail supports 180. The slider block rails 182 can be inserted into slots in rail supports 180, or may be welded or mechanically attached. Four slider blocks 190 are slidably engaged with the slider block rails, two on each rail, 182 as shown. The slider blocks 190 have a top surface 192 to which the upper plate 40 is mounted, as will be discussed herein.

The slide mechanism 70 further has a handwheel 172 attached to a shaft 174. The shaft 174 is disposed along one of the side supports 178, as shown. The shaft 174 is supported by bushing blocks 176, and by a gearbox 194. The gearbox 194 transmits rotational force from shaft 174 onto threaded lead screw 196, which is perpendicular to shaft 174. Lead screw 196, in turn, is attached to a lead block 198. Lead block 198 has internal threads and is engaged with threaded lead screw 196.

In use, rotational force is applied to the handwheel 172, and thereby shaft 174, to rotate the shaft 174 in a direction indicated by arrows 73. Rotational force is transmitted from shaft 174, through gearbox 194, to lead screw 196 causing the lead screw 196 to rotate in the direction indicated by arrows 193. Lead block 198, being threadably engaged with lead screw 196, thereby moves in a direction indicated by arrows 71. The lead block 198 is attached to the bottom surface of upper plate 40 and therefore imparts movement to the upper plate 40 in the direction of arrows 71.

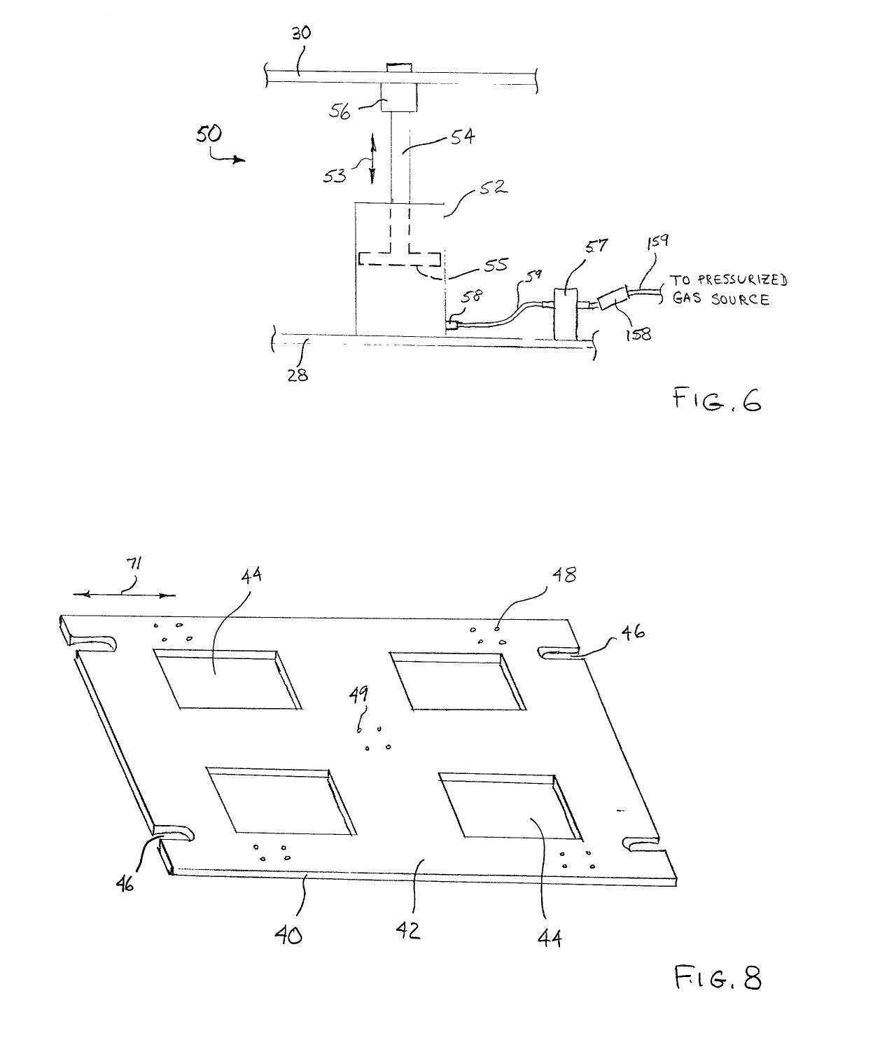

The upper plate 40 is illustrated in FIG. 8. The upper plate 40 may be mounted to the slider blocks 190 and lead block 198 by mechanical fasteners through holes 48, 49, respectively, or by other methods such as welding. In use, the upper plate 40 is moved by movement of the lead block 198, as described above. Slider blocks 190 move together with the upper plate 40 and enable smooth motion of the upper plate. The upper plate further has four slots 46, as shown, that can accommodate the jacking screw housings 89 as the upper plate 40 moves in the direction of arrows 71. The spatial relation between the jacking screw housings 89 and slots 46 is best illustrated in FIG. 1. The upper plate 40 further has openings 44 that offer weight savings for the resulting structure.

The lift and align table in accordance with the present invention can further include a second slide mechanism 70 to enable alignment in a direction perpendicular to the direction indicated by arrows 71. For example, a second slide mechanism can be mounted on the top surface 42 of the upper plate 40. The second slide mechanism would be installed so that the direction of the movement of the lead block 198 is perpendicular to the direction of arrows 71. Then, another top plate would be installed over the second slide mechanism, as described above, thereby allowing adjustments of the top plate, using the two slide mechanisms, in two directions within the same plane, namely in the direction of arrows 71 and in a direction perpendicular to arrows 71.

The lift table described herein can lift and align a heavy or awkward object to another abject, or storing area, as follows. With reference to FIGS. 1-8, an object to be aligned (not shown) is placed onto the upper mounting plate 40 of the lift table 10. The lift table 10 is then rolled toward the desired destination of the object in a direction 25 utilizing the wheels 21. Alternatively, the lift table 10 can be rolled in various directions if wheels 21 are swivel-type wheels. After the table 10 within desired proximity of the destination for the object, the lift mechanism 60 is operated by rotating handwheel 62 to raise or lower the middle plate 30, and thereby the upper plate 40, in a direction indicated by arrows 61. After the object is at a desirable height, final adjustments are made to bring the upper plate 40 adjacent the destination for the object. As described above, handwheel 172 is rotated, thereby translating lead block 198 and attached upper plate 40 in a direction indicated by arrows 71. After the object on the upper plate 40 is in a desirable position, the object is transferred to its destination by either manual or mechanical means.

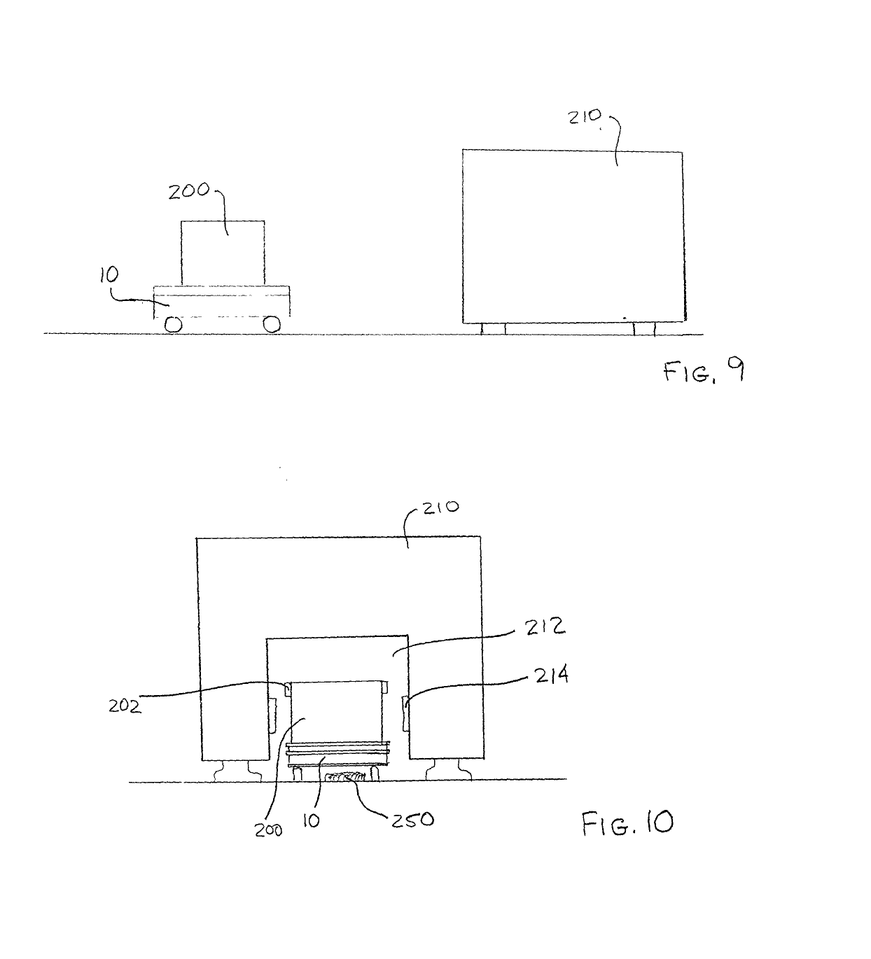

An exemplary use for the lift and align table of the present invention is to align a test head to a handler unit as used in semiconductor chip industry. With reference to FIGS. 9 and 10, a test head 200, loaded onto the lift and align table 10 using a manual or mechanical means, is moved toward a handler unit 210. As the lift and align table 10 reaches a desired destination within the handler unit 210, lifting and aligning operations are performed as described above. When the test head 200 is in a desirable position, handler unit support mechanisms 214 engage test head brackets 202 to secure the test head 200 in place. The lift and align table is then lowered and removed form the handler unit 210. Thereafter, testing or processing of semiconductor chips may be carried out. FIG. 10 also shows cables 250 that are cleared by the lift and align table of the present invention.

While exemplary embodiments of the invention have been described and illustrated, it should be apparent that many modifications can be made to the present inventions without departing from its spirit and scope. For example, while rotational force to operate handwheels 62 and 172 is manual, shafts 64 and 174 can be attached to a mechanical source of rotational force, such as a motor. Additionally, top surface 42 of the upper plate may be differently shaped to support objects having unique surfaces. Accordingly the invention is not limited by the foregoing description or drawings, but is only limited by the scope of the appended claims.

What is claimed as new and desired to be protected by Letters Patent of the United States is:

1. An apparatus for positioning an object comprising:
a first section having a lifting mechanism capable of movement in a vertical direction;
a second section disposed over said lifting mechanism capable of moving corresponding to said lifting mechanism, said second section having a first sliding mechanism capable of movement in a first horizontal direction; and
a third section disposed over said sliding mechanism capable of moving in response to movement of said sliding mechanism and said lifting mechanism, said third section having a surface for supporting an object.

2. The apparatus according to claim 1 wherein said lifting mechanism comprises a jacking screw mechanism.

3. The apparatus according to claim 1 wherein said lifting mechanism comprises a gas cylinder assembly.

4. The apparatus according to claim 1 wherein said lifting mechanism comprises a jacking screw mechanism and a gas cylinder assembly.

5. The apparatus according to claim 1 wherein said sliding mechanism comprises a lead screw and block mechanism.

6. The apparatus according to claim 5 wherein said sliding mechanism further comprises slider blocks having slide rails.

7. The apparatus according to claim 3 further comprising a pressurized gas source for said gas cylinder assemblies.

8. The apparatus according to claim 1 wherein said lifting mechanism comprises hydraulic cylinder assemblies.

9. The apparatus according to claim 8 further comprising a pressurized hydraulic fluid source for said hydraulic cylinder assemblies.

10. The apparatus according to claim 1 wherein said first section comprises wheels for moving said apparatus in a second horizontal direction perpendicular to said first horizontal direction.

11. The apparatus according to claim 11 wherein said first section further comprises a clearance between said first section and an underlying surface whereby said apparatus can clear obstacles when moving in said second horizontal direction.

12. The apparatus according to claim 1 further comprising a second sliding mechanism over said third section capable of motion in a second horizontal direction perpendicular to said first horizontal direction, and a fourth section disposed over said second sliding mechanism capable of motion in said vertical direction, first horizontal direction and second horizontal direction.

13. An adjustable support for positioning a piece of equipment comprising:
a base frame, a first section, and a second section;
a lifting mechanism disposed between said base frame and said first section for lifting and lowering said first section in a vertical direction with respect to said base frame; and
a first sliding mechanism disposed between said first section and said second section for sliding said second section with respect to said first section, said sliding occurring in a direction perpendicular to said vertical direction, said second section having a surface to support a piece of equipment.

14. The support according to claim 13 wherein said lifting mechanism comprises a jacking screw mechanism.

15. The support according to claim 13 wherein said lifting mechanism comprises a gas cylinder assembly.

16. The support according to claim 13 wherein said lifting mechanism comprises a jacking screw mechanism and a gas cylinder assembly.

17. The support according to claim 13 wherein said sliding mechanism comprises a lead screw and block mechanism.

18. The support according to claim 17 wherein said sliding mechanism further comprises slider blocks having slide rails.

19. The support according to claim 15 further comprising a pressurized gas source for said gas cylinder assemblies.

20. The support according to claim 13 wherein said lifting mechanism comprises hydraulic cylinder assemblies.

21. The support according to claim 20 further comprising a pressurized hydraulic fluid source for said hydraulic cylinder assemblies.

22. The support according to claim 13 wherein said base frame further comprises wheels for translating said support along an underlying surface.

23. The apparatus according to claim 22 wherein said base frame further comprises a clearance between said base frame and said underlying surface such that said apparatus can bypass obstructions when translating along said underlying surface.

24. The support according to claim 13 further comprising a third section containing a second sliding mechanism disposed over said second section, said second sliding mechanism being operable to move said third section in a direction different than the direction of the first sliding mechanism, said third section having a surface for supporting said piece of equipment.

25. An apparatus for supporting an object, said apparatus having a mechanism for lifting and lowering the object in a vertical direction and a separate mechanism for sliding an object in a first horizontal direction, said apparatus having wheels for rolling along a surface in a second horizontal direction orthogonal to said first horizontal direction.

26. The apparatus according to claim 25 wherein said lifting mechanism comprises a jacking screw mechanism.

27. The apparatus according to claim 25 wherein said lifting mechanism comprises a gas cylinder assembly.

28. The apparatus according to claim 25 wherein said lifting mechanism comprises a jacking screw mechanism and a gas cylinder assembly.

29. The apparatus according to claim 25 wherein said sliding mechanism comprises a lead screw and block mechanism.

30. The apparatus according to claim 29 wherein said sliding mechanism further comprises slider blocks having slide rails.

31. The apparatus according to claim 27 further comprising a pressurized gas source for said gas cylinder assemblies.

32. The apparatus according to claim 25 wherein said lifting mechanism comprises hydraulic cylinder assemblies.

33. The apparatus according to claim 32 further comprising a pressurized hydraulic fluid source for said hydraulic cylinder assemblies.

34. An apparatus for positioning an object comprising:
a support frame having wheels for rolling said apparatus in a first horizontal direction;
a lifting and lowering mechanism disposed over said support frame, said lifting and lowering mechanism comprising at least four jacking screws having a transmission system for operation of said jacking screws, said lifting and lowering system further comprising at least two gas cylinders having a pressurized gas source for operating said gas cylinders, wherein said gas cylinders assist said jacking screws in said lifting and lowering mechanism;
a first plate connected to said lifting and lowering mechanism such that said lifting and lowering mechanism imparts motion to said first plate;
a sliding mechanism disposed over said first plate, said sliding mechanism comprising a block having a transmission system for moving said block a second horizontal direction perpendicular to said first horizontal direction;
a second plate disposed over said sliding mechanism and attached to said block such that said sliding mechanism, said lifting and lowering mechanism, and the rolling of said wheels impart motion to said second plate, said second plate having a surface for supporting an object.

35. A method for positioning an object comprising:
providing a table having a support section adapted to move vertically and horizontally;
placing an object on said support section; moving said table toward a desired destination for said object; operating a lift mechanism to move said support section vertically; operating a slide mechanism to move said support section horizontally; said object being positioned in a desired location by said moving and operating actions.

36. The method according to claim 35 wherein operating said lift mechanism comprises manually rotating an input shaft attached to jacking mechanisms.

37. The method according to claim 35 wherein operating said lift mechanism comprises supplying a pressurized gas to gas cylinder assemblies.

38. The method according to claim 35 wherein operating said lift mechanism comprises manually rotating an input shaft attached to jacking mechanisms and supplying a pressurized gas to gas cylinder assemblies.

39. The method according to claim 35 wherein operating said slide mechanism comprises manually rotating a shaft attached to a lead screw.

40. The method according to claim 35 wherein moving said table comprises rolling said table utilizing wheels.

41. A method for transferring an object comprising:
providing a base frame, a top frame, and a middle frame disposed between said base frame and said top frame;
providing a lift mechanism between said base frame and said middle frame;
providing a slide mechanism between said middle frame and said top frame;
placing said object on said top frame; and
operating said lift mechanism and said slide mechanism to deliver said object to a desired position.

42. The method according to claim 41 wherein operating said lift mechanism comprises manually rotating an input shaft attached to jacking mechanisms.

43. The method according to claim 41 wherein operating said lift mechanism comprises supplying a pressurized gas to gas cylinder assemblies.

44. The method according to claim 41 wherein operating said lift mechanism comprises manually rotating an input shaft attached to jacking mechanisms and supplying a pressurized gas to gas cylinder assemblies.

45. The method according to claim 41 wherein operating said slide mechanism comprises manually rotating a shaft attached to a lead screw.

46. The method according to claim 41 further comprising rolling said base frame utilizing wheels.
